(19) United States
(12) Patent Application Publication
(10) Pub. No.: US 2025/0362192 A1
(43) Pub. Date: Nov. 27, 2025

(54) FIBER BRAGG GRATINGS (FBGS)-BASED SIX-DIMENSIONAL STRAIN SENSOR FOR MONITORING SPATIAL PRINCIPAL STRAIN AND MULTIDIMENSIONAL STRAIN DECOUPLING METHOD THEREOF

(71) Applicant: Taiyuan University of Technology, Taiyuan City (CN)

(72) Inventors: Xiao DENG, Taiyuan City (CN); Bin JIA, Taiyuan City (CN); Zhuoke QIN, Taiyuan City (CN); Chao DU, Taiyuan City (CN); Lin ZHANG, Taiyuan City (CN); Liqin CUI, Taiyuan City (CN); Li ZHANG, Taiyuan City (CN)

(73) Assignee: Taiyuan University of Technology, Taiyuan City (CN)

(21) Appl. No.: 19/008,128

(22) Filed: Jan. 2, 2025

(30) Foreign Application Priority Data
Jan. 8, 2024 (CN) 202410025746.1

(51) Int. Cl. G01L 1/24; G01K 11/3206

(52) U.S. Cl. CPC G01L 1/246; G01K 11/3206

(57) ABSTRACT

Provided is a fiber Bragg gratings (FBGs)-based six-dimensional strain sensor for monitoring a spatial principal strain, which belongs to the field of fiber grating strain sensing technologies. The FBGs-based six-dimensional strain sensor has six strain sensing units of a same structure that are arranged in six spatial directions of X, Y, Z, XY, XZ, and YZ, and also has a temperature sensing unit. By designing an integrated six-dimensional strain sensor, this application achieves simultaneous monitoring of strains in the six spatial directions, to obtain a distribution status of complex strains and the principal strain in internal space of a measured object. A six-dimensional strain sensor is designed with a multifunctional strain decoupling apparatus. A sensor strain decoupling model based on a BP-neural network is established according to calibration data of the decoupling apparatus. This application is applicable to the field of multidimensional spatial strain measuring.

### CROSS REFERENCE TO RELATED APPLICATION

This patent application claims the benefit and priority of Chinese Patent Application No. 2024100257461, filed with the China National Intellectual Property Administration on Jan. 8, 2024, the disclosure of which is incorporated by reference herein in its entirety as part of the present application.

### TECHNICAL FIELD

The present disclosure belongs to the field of fiber grating strain sensing technologies, and relates to a fiber Bragg gratings (FBGs)-based six-dimensional strain sensor for monitoring a spatial principal strain and a multidimensional strain decoupling method thereof.

### BACKGROUND

Fiber grating spatial strain sensing shifts with a center wavelength generated by a fiber Bragg grating (FBG) due to external deformation. A strain value measured by each sensing unit is determined according to a mathematic relationship between a center wavelength offset, obtained through calibration experiment, of the FBG and a strain, and a strain distribution status and a principal strain in measured space are calculated by using strain values in a plurality of directions based on a spatial strain equation. At present, a fiber grating spatial strain sensing apparatus mostly utilizes a plurality of independent FBG strain sensing apparatuses to form an array, so that large spatial strains in different directions are measured. This leads to problems of dispersed measurement points, a large size, and inaccurate temperature compensation.

In addition, the conventional measurement method is limited by a structure and a layout manner of a sensing apparatus, and therefore, mutual-interference coupling effect is generated during strain measurement in a plurality of directions. This leads to the disadvantages of a severe measurement error, and the like, and consequently, accurate measurement in the plurality of directions cannot be implemented. Therefore, it is of great significance to provide a fiber grating six-dimensional sensing apparatus for monitoring a spatial principal strain and a multidimensional strain decoupling method thereof.

### SUMMARY

To resolve the technical problems in the present disclosure, an FBGs-based six-dimensional strain sensor is provided to resolve the disadvantages in the conventional technology. In addition, a multidimensional strain decoupling apparatus and method for a sensing apparatus are provided based on the provided sensing apparatus.

The present disclosure resolves the technical problems with the following technical solutions.

An FBGs-based six-dimensional strain sensor for monitoring a spatial principal strain is provided. As shown in FIG. 1, the FBGs-based six-dimensional strain sensor has six strain sensing units of a same structure, that are arranged in six spatial directions of X, Y, Z, XY, XZ, and YZ, and also has a temperature sensing unit arranged inside a base of the FBGs-based six-dimensional strain sensor to achieve temperature compensation in a strain measurement process of the FBGs-based six-dimensional strain sensor. Details are as follows.

The FBGs-based six-dimensional strain sensor mainly includes a bracket 1, the base 10, the six strain sensing units that are respectively disposed in the six directions and have a same structure, the temperature sensing unit, optical fibers 5, a cylindrical encapsulation structure 8, and a temperature FBG 9, where each of the six strain sensing units includes two circular discs 2, a hollow cylindrical tube 3, and strain FBGs 4; and the temperature sensing unit includes a cover plate 6, a cylindrical cavity 7, and the cylindrical encapsulation structure 8. Components other than the fiber grating FBG 4 and the optical fiber 5 are integrally manufactured through 3D printing, and are mutually integrated.

The bracket 1 is configured to support the six strain sensing units in the six spatial directions of X, Y, Z, XY, XZ, and YZ, and each of the six strain sensing units includes two circular discs 2, one hollow cylindrical tube 3, and a fiber grating FBG 4 encapsulated inside the hollow cylindrical tube 3. The FBG 4 is located in a center of the hollow cylindrical tube 3, and is fixed with an inner wall of the tube by using a fixative, so that the FBG 4 can have synchronous deformation with the hollow cylindrical tube 3 during strain measurement while the FBG 4 is prevented from a chirp phenomenon. The two circular discs 2 are arranged on an outer wall surface of the hollow cylindrical tube 3, the hollow cylindrical tube 3 and the two circular discs 2 form a dumbbell-like hollow structure, and the circular disc 2 is configured to prevent sliding relative to a measured object in a measurement process. Bottoms of the six strain sensing units are fixed on the base 10. The base 10 is of a hollow cylindrical structure, and is internally nested with a coaxial hollow circular tube, the cylindrical encapsulation structure 8 and the temperature FBG 9 are disposed in the circular tube, the cover plate 6 is disposed on a top of the circular tube, a through hole for allowing the fiber grating FBG 4 to pass through is formed in a middle of the cover plate, and the fiber grating FBG 4 is connected to the temperature FBG 9. The cylindrical cavity 7 is provided between the cylindrical encapsulation structure 8 and the cover plate 6.

Seven FBGs (including six strain FBGs 4 and one temperature FBG 9) are cascaded together and arranged in the FBGs-based six-dimensional strain sensor in sequence. One end that is of the hollow cylindrical tube 3 and that is close to the base 10 is defined as an inner end, and the other end of the hollow cylindrical tube 3 is defined as an outer end. A first FBG gets in from the outer end of the hollow cylindrical tube 3 in the YZ direction and is fixed in the hollow cylindrical tube 3 in the YZ direction; after the first FBG 4 is fixed, an optical fiber guided out from the outer end of the hollow cylindrical tube 3 in the YZ direction gets in the hollow cylindrical tube 3 in the Y direction, and a second FBG 4 is fixed in the hollow cylindrical tube 3 in the Y direction; an optical fiber guided out from the inner end of the hollow cylindrical tube 3 in the Y direction gets in from the inner end of the hollow cylindrical tube 3 in the XY direction, and a third FBG 4 is fixed in the hollow cylindrical tube 3 in the XY direction; an optical fiber guided out from the outer end of the hollow cylindrical tube 3 in the XY direction gets in from the outer end of the hollow cylindrical tube 3 in the X direction, and a fourth FBG 4 is fixed in the hollow cylindrical tube 3 in the X direction; an optical fiber guided out from the inner end of the hollow cylindrical tube 3 in the X direction gets in from the inner end of the hollow cylindrical tube 3 in the XZ direction, and a fifth FBG 4 is fixed in the hollow cylindrical tube 3 in the XZ direction; an optical fiber guided out from the outer end of the hollow cylindrical tube 3 in the XZ direction gets in from the outer end of the hollow cylindrical tube 3 in the Z direction, and a sixth FBG 4 is fixed in the hollow cylindrical tube 3 in the Z direction; and an optical fiber (tail end of which is provided with the temperature FBG 9) guided out from an inner end of the hollow cylindrical tube 3 in the Z direction gets into the cavity 7 of the base 10, thereby completing arrangement of the six strain FBGs 4 and the one temperature FBG 9.

The one temperature FBG 9 is arranged in a cavity of the base 10, to eliminate temperature interference in the measurement process; and the temperature FBG 9 is only affected by a temperature and is not affected by deformation of an external sensing apparatus, and is configured to perform temperature compensation as the temperature sensing unit. The temperature sensing unit is arranged in the base 10, and a cylindrical cavity 7 is provided in the base 10. An FBG fiber 4 fixed on an optical fiber guided out from the inner end of the hollow cylindrical tube 3 in the Z direction passes through the circular cover plate 6 with a hole, and then is fixed in the cylindrical encapsulation structure 8 by using a fixative. A diameter of the cylindrical encapsulation structure 8 is less than a diameter of the cavity 7 in which a hollow groove for allowing the optical fiber to pass through is provided. The cylindrical encapsulation structure 8 in which the FBG 4 is fixed is placed in the cavity 7, and the cavity is sealed via the cover plate 6, making the encapsulated FBG 4 in the cavity only affected by a temperature and not affected by external force, to finally form the temperature sensing unit of the FBGs-based six-dimensional strain sensor.

The finally designed FBGs-based six-dimensional strain sensor is capable of converting strains in the six spatial directions of X, Y, Z, XY, XZ, and YZ inside the measured object into changes of center wavelength values (λ_{FBG}) corresponding to cascaded FBGs of the FBGs-based six-dimensional strain sensor to implement measurement of the spatial principal strain. The principle is as follows.

Influences of a temperature and a strain on λ_{FBG} are independent and linear (as shown in formula 1),

$$Δ {λ}_{F B G} = {k}_{T} Δ T + {k}_{ε} Δ ε , \qquad ( 1 )$$

where

k_{T} indicates a temperature coefficient of an FBG, k_{ε} indicates a strain coefficient of the FBG, ΔT and Δε respectively indicate a variation of the temperature and a variation of the strain. Therefore, a temperature of the measured object can be calculated according to a center wavelength offset of the temperature sensing unit in the sensor, to eliminate center wavelength offsets, caused by the temperature, of the strain sensing units in the six directions, so as to implement temperature compensation for strain measurement. Strains (εₓ, ε_{y}, ε_{z}, ε_{xy}, ε_{xz}, ε_{yz}) in the six spatial directions of X, Y, Z, XY, XZ, and YZ, can be obtained according to changes of center wavelengths of seven cascaded FBGs in the sensing apparatus, as shown in formula (2), where T₀ and ε₀ are initial values of the temperature and the strain. Formula (2) is a mathematical model designed for the FBGs-based six-dimensional strain sensor.

$$[ \begin{matrix}{ε}_{x} \\ {ε}_{y} \\ {ε}_{𝓏} \\ {ε}_{xy} \\ {ε}_{x 𝓏} \\ {ε}_{y 𝓏} \\ T\end{matrix} ] = [ \begin{matrix}{k}_{ε x}^{- 1} & 0 & 0 & 0 & 0 & 0 & - {{k}_{Tx} ( {k}_{T} {k}_{ε x} )}^{- 1} \\ 0 & {k}_{ε y}^{- 1} & 0 & 0 & 0 & 0 & - {{k}_{Ty} ( {k}_{T} {k}_{ε y} )}^{- 1} \\ 0 & 0 & {k}_{ε 𝓏}^{- 1} & 0 & 0 & 0 & - {{k}_{T 𝓏} ( {k}_{T} {k}_{ε 𝓏} )}^{- 1} \\ 0 & 0 & 0 & {k}_{ε xy}^{- 1} & 0 & 0 & - {{k}_{Txy} ( {k}_{T} {k}_{ε xy} )}^{- 1} \\ 0 & 0 & 0 & 0 & {k}_{ε y 𝓏}^{- 1} & 0 & - {{k}_{Tx 𝓏} ( {k}_{T} {k}_{ε x 𝓏} )}^{- 1} \\ 0 & 0 & 0 & 0 & 0 & {k}_{ε y 𝓏}^{- 1} & - {{k}_{Tx 𝓏} ( {k}_{T} {k}_{ε x 𝓏} )}^{- 1} \\ 0 & 0 & 0 & 0 & 0 & 0 & {k}_{T}\end{matrix} ] [ \begin{matrix}{Δλ}_{x} \\ {Δλ}_{y} \\ {Δλ}_{𝓏} \\ {Δλ}_{xy} \\ {Δλ}_{x 𝓏} \\ {Δλ}_{y 𝓏} \\ {Δλ}_{T}\end{matrix} ] + [ \begin{matrix}{ε}_{x 0} \\ {ε}_{y 0} \\ {ε}_{𝓏 0} \\ {ε}_{xy 0} \\ {ε}_{x 𝓏 0} \\ {ε}_{y 𝓏 0} \\ {T}_{0}\end{matrix} ] \qquad ( 2 )$$

A group of strain values, measured by the sensing apparatus, in the six directions are substituted into a formula (3) to obtain six basic strain components (εₓ, ε_{y}, ε_{z}, ε_{xy}, ε_{yz}, ε_{xz}) that indicate spatial strain.

$${γ}_{xy} = 2 {ε}_{xy} - {ε}_{x} - {ε}_{y} \qquad ( 3 )$$

$${γ}_{y 𝓏} = 2 {ε}_{y 𝓏} - {ε}_{y} - {ε}_{𝓏}$$

$${γ}_{𝓏 x} = 2 {ε}_{𝓏 x} - {ε}_{𝓏} - {ε}_{x ,}$$

where

γ_{xy}, γ_{yz}, and γ_{zx} respectively indicate spatial shear strains in an XY plane, a YZ plane, and a ZX plane. A normal strain and a shear strain of a measured point on any section can be obtained through the six basic strain components. Therefore, a three-dimensional spatial strain state of the point can be completely determined through the six strain components. The strain components are substituted into a spatial principal strain equation (4).

$${ε}^{3} - {I}_{1} {ε}^{2} + {I}_{2} ε - {I}_{3} = 0 \qquad ( 4 )$$

I₁, I₂, and I₃ in the formula (4) are respectively a first invariant, a second invariant, and a third invariant of a strain tensor, which can be calculated according to the formula (5).

$${I}_{1} = {ε}_{x} + {ε}_{y} + {ε}_{𝓏} \qquad ( 5 )$$

$${I}_{2} = {ε}_{y} {ε}_{𝓏} + {ε}_{𝓏} {ε}_{x} + {ε}_{x} {ε}_{y} - \frac{{γ}_{𝓏 x}^{2} + {γ}_{y 𝓏}^{2} + {γ}_{xy}^{2}}{4}$$

$${I}_{3} = {ε}_{x} {ε}_{y} {ε}_{𝓏} - \frac{{ε}_{x} {γ}_{y 𝓏}^{2} + {ε}_{y} {γ}_{𝓏 x}^{2} + {ε}_{𝓏} {γ}_{xy}^{2}}{4} + \frac{{γ}_{xy} {γ}_{y 𝓏} {γ}_{𝓏 x}}{4}$$

The spatial principal strain equation (4) is resolved according to the formula (5), so that sizes of a first principal strain ε₁, a second principal strain ε₂, and a third strain ε₃ can be obtained. A principal strain direction cosine equation set (6) is introduced to determine the direction of the principal strain.

$$\{ \begin{matrix}2 ( {ε}_{x} - {ε}_{i} ) l + {γ}_{xy} m + {γ}_{𝓏 x} n = 0 \\ {γ}_{xy} l + 2 ( {ε}_{y} - {ε}_{i} ) m + {γ}_{y 𝓏} n = 0 \\ {γ}_{𝓏 x} l + {γ}_{y 𝓏} m + 2 ( {ε}_{z} - {ε}_{i} ) n = 0\end{matrix} , \qquad ( 6 )$$

where

ε₁, ε₂, and ε₃ are sequentially substituted into a; in the formula (6) to obtain direction cosine values l, m and n of included angles between the principal strains and three coordinate axes: X, Y, and Z, which satisfy the following relationship:

$${l}^{2} + {m}^{2} + {n}^{2} = 1 \qquad ( 7 )$$

According to the cosine values of the principal strain on the coordinate axes, an angle between the principal strain and each coordinate axis can be calculated according to formula (7), where θ_{X} indicates an included with the X-axis, θ_{Y} indicates an included angle with the Y-axis, and θ_{Z} indicates an included angle with the Z-axis. A principal strain distribution status in the three-dimensional space can be finally determined according to a size and direction of the principal strain.

$${θ}_{X} = arccos l l ∈ [ - 1 , 1 ] \qquad ( 8 )$$

$${θ}_{Y} = arccos m m ∈ [ - 1 , 1 ]$$

$${θ}_{Z} = arccos n n ∈ [ - 1 , 1 ]$$

A measurement mutual interference problem among six sensing spatial directions should be considered during measurement, to improve strain sensing precision of a multidimensional strain sensing apparatus. Therefore, a multidimensional strain decoupling apparatus and method is designed on the basis of the FBGs-based six-dimensional strain sensor. Details are as follows.

As shown in FIG. 2, a multidirectional strain decoupling calibration apparatus is configured to: fix the FBGs-based six-dimensional strain sensor, and perform multidirectional strain calibration on strain sensing units in the six directions of the FBGs-based six-dimensional strain sensor. The multidirectional strain decoupling calibration apparatus includes a fixed plate 11 on a bottom, a micro-displacement electric control box 12, calibration shafts 13, movable sliding blocks 14, connection rods 15, and fixtures 16. The fixed plate 11 serves as a base of the entire decoupling calibration apparatus, and does not move in a use process, to reduce an error caused by the shake of the apparatus in the decoupling calibration process. The micro-displacement electric control box 12 is tightly fixed with the fixed plate 11 through a screw; and is connected to the calibration shafts 13 arranged in the six directions. Two movable sliding blocks 14 are disposed on each calibration shaft 13, and each movable block 14 is capable of independently moving along the calibration shafts 13 under control of the micro-displacement electric control box 12. One connection rod 15 is provided on each movable sliding block 14, and the fixture 16 is fixed on the movable sliding block 14 and is capable of moving along the calibration shaft 13. Circular discs 2 of the strain sensing unit in each direction of the FBGs-based six-dimensional strain sensor are placed into the fixtures 16 in corresponding directions, and the strain sensing units in the six directions are fixed via the fixtures 16; and in a multidirectional strain decoupling calibration process, the circular discs 2 in the FBGs-based six-dimensional strain sensor are driven by the fixtures 16 to move, so as to apply a displacement load to the strain sensing units.

The micro-displacement electric control box 12 is a central control part in the entire calibration decoupling apparatus, and is capable of independently controlling the fixture 16 in each direction to move, and the fixture 16 has a compressing or stretching displacement under control of the micro-displacement electric control box 12, or is in a free state without force; and therefore, complex strains in a plurality of spatial directions are simulated. A multidirectional strain calibration experiment is performed on the FBGs-based six-dimensional strain sensor via the multidimensional strain decoupling calibration apparatus to obtain complete calibration data (a strain of the sensing unit and a center wavelength offset of the FBG 4), and the complete calibration data is substituted into a BP-neural network algorithm to implement multidimensional strain decoupling of the FBGs-based six-dimensional strain sensor.

A multidimensional strain decoupling method is implemented based on the calibration apparatus, and specifically includes the following steps.

A first step, fixing an FBGs-based six-dimensional strain sensor on the decoupling apparatus as shown in FIG. 2, and placing a circular disc 2 into a fixture 16 in a corresponding direction for moving along with the fixture 16 to deform, where the decoupling fixture 16 is controlled to apply a stretching strain and a compressing strain to a sensing unit in an X direction in the FBGs-based six-dimensional strain sensor, and the straining strain and the compressing strain are recorded as T_{X} and C_{X}.

A second step, calibrating a single strain sensing unit of a six-dimensional strain sensor:

Controlling two fixtures 16 in the X direction to drive two circular discs 2 on the sensing unit to move, and fixtures 16 in other five directions not to move, making strain sensing units in a Y direction, a Z direction, an XY direction, an XZ direction, and a YZ direction in a free state without force. The two fixtures 16 in the X direction are controlled by a micro-displacement electric control box 12 to get close to each other and the compressing strain (C_{X}) is applied to the strain sensing unit in the X direction, and then the fixtures 16 are made to be away from each other and the stretching strain (T_{X}) is applied to the strain sensing unit in the X direction, where there are 2 calibration combinations in total; and strain values applied to the strain sensing units in the six directions and offsets of center wavelengths of FBGs 4 of the strain sensing units in the six directions in the process are recorded.

Similarly, a single strain sensing unit in each of other five directions is sequentially calibrated, and corresponding calibration data is obtained. Calibration data of all single strain sensing units are recorded as S1, where there are 12 calibration combinations.

A third step, calibrating two strain sensing units of the six-dimensional strain sensor:

Controlling fixtures 16 in the X and Y directions on the decoupling apparatus to drive circular discs 2 on the strain sensing units in the X and Y directions, and applying strains to the strain sensing units in the X and Y directions of the FBGs-based six-dimensional strain sensor, and making strain sensing units in other directions in a free state without external force. A strain applying sequence is as follows: C_{X}-C_{Y} (that is, the sensing unit in the X direction of the FBGs-based six-dimensional strain sensor is compressed while the sensing unit in the Y direction is compressed), C_{X}-T_{Y}, T_{Y}-C_{Y}, and T_{Y}-T_{Y}, where there are 4 calibration combinations in total. Strain values applied to the strain sensing units in the six directions and offsets of center wavelengths of FBGs 4 of the strain sensing units in the six directions in the entire process are simultaneously recorded, to obtain center wavelength response rules of the FBGs 4 of the six sensing units of the FBGs-based six-dimensional strain sensor when the sensing units in the X and Y directions are simultaneously strained.

Similarly, cases in which two strain sensing units in each of other fourteen groups of directions in total: X-Z, X-XY, X-XZ, X-YZ, Y-Z, Y-XY, Y-XZ, Y-YZ, Z-XY, Z-XZ, Z-YZ, XY-XZ, XY-YZ, and XZ-YZ, are simultaneously strained are sequentially calibrated. Calibration data of all of every two strain sensing units are recorded as S2, where there are 60 calibration combinations.

A fourth step, simultaneously calibrating three strain sensing units of the six-dimensional strain sensor:

Strains are simultaneously applied to the strain sensing units in the X, Y, and Z directions by using the fixtures 16 of the decoupling apparatus in a sequence of C_{X}-C_{Y}-C_{Z}, C_{X}-C_{Y}-T_{Z}, C_{X}-T_{Y}-C_{Z}, C_{X}-T_{Y}-T_{Z}, T_{X}-C_{Y}-C_{Z}, T_{X}-C_{Y}-T_{Z}, T_{X}-T_{Y}-C_{Z}, and T_{X}-T_{Y}-T_{Z}, where there are 8 calibration combinations in total. Strain values applied to the strain sensing units in the six directions and offsets of center wavelengths of FBGs 4 of the strain sensing units in the six directions in the entire process are simultaneously recorded, to obtain center wavelength response rules of the FBGs 4 of the six sensing units of the FBGs-based six-dimensional strain sensor when the sensing units in the X, Y, and Z directions are simultaneously strained.

Similarly, strains are simultaneously applied to strain sensing units in twenty groups of directions in total: X-Y-XY, X-Y-XZ, X-Y-YZ, Y-Z-XY, Y-Z-XZ, Y-Z-YZ, Z-XY-XZ, Z-XY-YZ, . . . , XY-XZ-YZ in sequence. Calibration data when all of every three strain sensing units are simultaneously strained are recorded as S3, where there are 160 calibration combinations.

A fifth step, simultaneously calibrating four strain sensing units of the six-dimensional strain sensor:

Simultaneously applying strains to the strain sensing units in the X, Y, Z, and XY directions by using the fixtures 16 of the decoupling apparatus in a sequence of C_{X}-C_{Y}-C_{Z}-C_{XY}, C_{X}-C_{Y}-C_{Z}-T_{XY}, C_{X}-C_{Y}-T_{Z}-C_{XY}, C_{X}-C_{Y}-T_{Z}-T_{XY}, C_{X}-T_{Y}-C_{Z}-C_{XY}, C_{X}-T_{Y}-C_{Z}-T_{XY}, C_{X}-C_{Y}-T_{Z}-C_{XY}, C_{X}-C_{Y}-T_{X}-T_{XY}, T_{X}-C_{Y}-C_{X}-C_{XY}, T_{X}-C_{Y}-C_{Z}-T_{XY}, T_{X}-C_{Y}-T_{Z}-C_{XY}, T_{X}-C_{Y}-T_{Z}-T_{XY}, T_{X}-T_{Y}-C_{Z}-C_{XY}, T_{X}-T_{Y}-C_{Z}-T_{XY}, T_{X}-C_{Y}-T_{Z}-C_{XY}, and T_{X}-C_{Y}-T_{Z}-T_{XY}, where there are 16 calibration combinations in total; and recording strain values applied to the strain sensing units in the six directions and offsets of center wavelengths of FBGs 4 of the strain sensing units in the six directions in the entire process, to obtain center wavelength response rules of the FBGs 4 of the six sensing units of the FBGs-based six-dimensional strain sensor when the sensing units in the X, Y, Z, and XY directions are simultaneously strained.

Similarly, strains are simultaneously applied to strain sensing units in fifteen groups of directions in total: X-Y-Z-XZ, X-Y-Z-YZ, Y-Z-XY-XZ, Y-Z-XY-YZ, . . . , and Z-XY-XZ-YZ in sequence. Calibration data when all of every four strain sensing units are simultaneously strained are recorded as S4, where there are 240 calibration combinations.

A sixth step, simultaneously calibrating five strain sensing units of the six-dimensional strain sensor:

Simultaneously applying strains to the strain sensing units in the X, Y, Z, XY, and XZ directions by using the fixtures 16 of the decoupling apparatus in a sequence of C_{X}-C_{Y}-C_{Z}-C_{XY}-C_{XZ}, C_{X}-C_{Y}-C_{Z}-C_{XY}-T_{XZ}, . . . , T_{X}-T_{Y}-T_{Z}-T_{XY}-T_{X}, where there are 32 calibration combinations in total; and recording strain values applied to the strain sensing units in the six directions and offsets of center wavelengths of FBGs 4 of the strain sensing units in the six directions in the entire process, to obtain center wavelength response rules of the FBGs 4 of the six sensing units of the FBGs-based six-dimensional strain sensor when the sensing units in the X, Y, Z, XY, and XZ directions are simultaneously strained.

Similarly, strains are simultaneously applied to strain sensing units in five groups of directions in total: Y-Z-XY-XZ-YZ, Z-XY-XZ-YZ-X, XY-XZ-YZ-X-Y, XZ-YZ-X-Y-Z, and YZ-X-Y-Z-XY. Calibration data when all of every five strain sensing units are simultaneously strained are recorded as S5, where there are 192 calibration combinations.

A seventh step, simultaneously calibrating six strain sensing units of the six-dimensional strain sensor:

Simultaneously applying strains to the strain sensing units in the X, Y, Z, XY, and XZ directions by using the fixtures 16 of the decoupling apparatus in a sequence of C_{X}-C_{Y}-C_{Z}-C_{XY}-C_{XZ}-C_{YZ}, C_{X}-C_{Y}-C_{Z}-C_{XY}-C_{XZ}-T_{YZ}, . . . , C_{X}-T_{Y}-T_{Z}-T_{XY}-T_{XZ}-T_{YZ}, and T_{X}-T_{Y}-T_{Z}-T_{XY}-T_{XZ}-T_{YZ}, where there are 64 calibration combinations in total; and recording strain values applied to the strain sensing units in the six directions and offsets of center wavelengths of FBGs 4 of the strain sensing units in the six directions in the entire process, to obtain center wavelength response rules of the FBGs 4 of the six sensing units of the FBGs-based six-dimensional strain sensor when the sensing units in the X, Y, Z, XY, and XZ directions are simultaneously strained. Calibration data when all of every five strain sensing units are simultaneously strained are recorded as S6, where there are 64 calibration combinations.

An eighth step, after multidirectional strain calibration is completed, obtaining 728 calibration combinations in total for calibration data (S1, S2, S3, S4, S5, and S6), where each calibration combination includes strains applied to the six strain sensing units and center wavelength values of FBGs 4 in the six strain sensing units; performing model training by taking center wavelengths of the six FBGs 4 as input (Δλx, Δλy, Δλz, Δλxy, Δλxz, Δλyz), and taking strains applied to the six strain sensing units as output (εx, εy, εz, εxy, εxz, εyz), and substituting the input and the output into a BP-neural network algorithm, to obtain a sensor strain decoupling model based on a BP-neural network (as shown in FIG. 3).

After the sensor strain decoupling model is obtained, a sensing signal (Δλₓ, Δλ_{y}, Δλ_{z}, Δλ_{xy}, Δλ_{xz}, Δλ_{yz}) of the FBGs-based six-dimensional strain sensor is substituted into the decoupling model when a spatial strain value is measured by the six-dimensional strain sensor, to obtain a more accurate decoupled spatial strain (εₓ, ε_{y}, ε_{z}, ε_{xy}, ε_{xz}, ε_{yz}) of a measured object in each direction at this moment.

The present disclosure has the following beneficial effects:

By designing the integrated six-dimensional strain sensor, the present disclosure achieves simultaneous monitoring of strains in the six spatial directions of X, Y, Z, XY, XZ, and YZ to obtain a distribution status of complex strains and the principal strain in internal space of the measured object. The six-dimensional strain sensor is designed with a multifunctional strain decoupling apparatus. A sensor strain decoupling model based on a BP-neural network is established according to the calibration data of the decoupling apparatus. The present disclosure is applicable to the field of multidimensional spatial strain measurement. The sensor can effectively improve synchronous measurement of multidimensional spatial strain, and has a temperature self-compensation capability. During spatial strain measurement, decoupling influences in a plurality of directions are overcome by the decoupling model, so that measurement accuracy of the FBGs-based six-dimensional strain sensor is improved, and practicability is good.

### BRIEF DESCRIPTION OF THE DRAWINGS

FIG. 1 is a schematic diagram of a structure of an FBGs-based six-dimensional strain sensor for monitoring a spatial principal strain according to the present disclosure, and a partially enlarged view of a Z-direction sensing unit of the sensing apparatus:

FIG. 2 is a schematic diagram and partially enlarged view of a multidimensional strain decoupling apparatus according to the present disclosure;

FIG. 3 shows a sensor strain decoupling model based on a BP-neural network;

FIGS. 4A-4F show measured value of a six-dimensional strain sensor, where FIG. 4A shows the X direction, FIG. 4B the Y direction, FIG. 4C the Z direction, FIG. 4D the XY direction, FIG. 4E the XZ direction, and FIG. 4F the YZ direction;

FIGS. 5A-5F show principal strain distribution inside frozen soil, where FIG. 5A shows a size of a principal strain, and included angles between the principal strain and X, Y, and X coordinate axes, FIG. 5B shows a first principal strain, FIG. 5C shows a second principal strain, FIG. 5D shows a third principal strain, and a distribution status of the principal strain in three-dimensional space, FIG. 5E shows principal strain distribution at a highest temperature, and FIG. 5F shows spatial strain distribution at a largest strain.

In the figures: 1, bracket; 2, circular disc; 3, hollow cylindrical tube; 4, fiber grating (FBG); 5, optical fiber; 6, cover plate; 7, cylindrical cavity; 8, cylindrical encapsulation structure; 9, temperature FBG; 10, base; 11, fixed plate; 12, micro-displacement electric control box; 13, calibration shaft; 14, movable sliding block; 15, connection rod; and 16, fixture.

### DETAILED DESCRIPTION OF THE EMBODIMENTS

In order to describe the technical features, objectives and effects of the present disclosure more clearly, the specific implementations of the present disclosure are described in detail below with reference to examples.

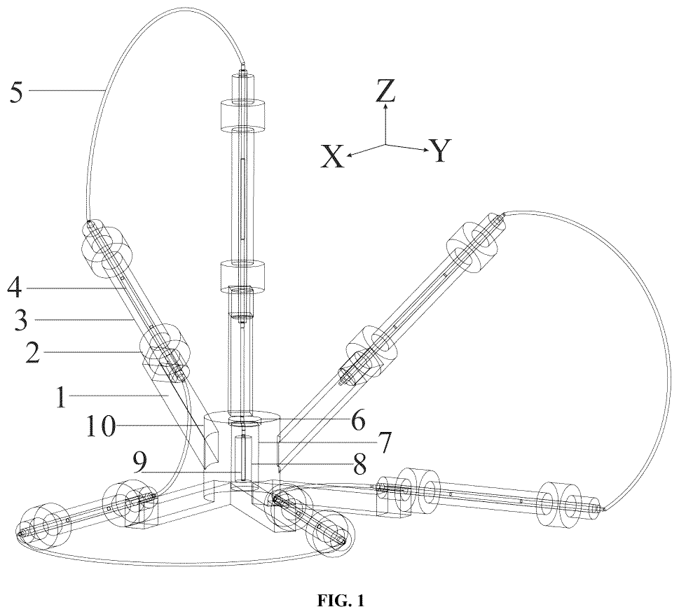

An FBGs-based six-dimensional strain sensor for monitoring a spatial principal strain is provided. As shown in FIG. 1, the FBGs-based six-dimensional strain sensor has six strain sensing units of a same structure, which are arranged in six spatial directions of X, Y, Z, XY, XZ, and YZ, and also has a temperature sensing unit arranged inside a base of the FBGs-based six-dimensional strain sensor to achieve temperature compensation in a strain measurement process of the FBGs-based six-dimensional strain sensor. The FBGs-based six-dimensional strain sensor mainly includes a bracket 1, the base 10, the six strain sensing units that are respectively disposed in the six directions and have a same structure, the temperature sensing unit, optical fibers 5, a cylindrical encapsulation structure 8, and a temperature FBG 9, where each of the strain sensing units includes circular discs 2, a hollow cylindrical tube 3, and strain FBGs 4; and the temperature sensing unit includes a cover plate 6, a cylindrical cavity 7, and the cylindrical encapsulation structure 8. Components other than the fiber grating FBG 4 and the optical fiber 5 are integrally manufactured through 3D printing, and are mutually integrated.

The bracket 1 is configured to support the strain sensing units in the six spatial directions of X, Y, Z, XY, XZ, and YZ, and each of the six strain sensing units includes two circular discs 2, one hollow cylindrical tube 3, and a fiber grating (FBG) 4 encapsulated inside the hollow cylindrical tube 3. The FBG 4 is located in a center of the hollow cylindrical tube 3, and is fixed with an inner wall of the tube by using a fixative, so that the FBG 4 can have synchronous deformation with the hollow cylindrical tube 3 during strain measurement while the FBG 4 is prevented from a chirp phenomenon. The two circular discs 2 are arranged on an outer wall surface of the hollow cylindrical tube 3, the hollow cylindrical tube 3 and the two circular discs 2 form a dumbbell-like hollow structure, and the circular disc 2 is configured to prevent sliding relative to a measured object in a measurement process. Bottoms of the six strain sensing units are fixed on the base 10. The base 10 is of a hollow cylindrical structure, and is internally nested with a coaxial hollow circular tube, the cylindrical encapsulation structure 8 and the temperature FBG 9 are disposed in the circular tube, the cover plate 6 is disposed on a top of the circular tube, a through hole for allowing the fiber grating FBG 4 to pass through is formed in a middle of the cover plate 6, and the fiber grating FBG 4 is connected to the temperature FBG 9. The cylindrical cavity 7 is provided between the cylindrical encapsulation structure 8 and the cover plate 6.

In this embodiment, the FBGs-based six-dimensional strain sensor is manufactured to measure a multidimensional complex strain in inner space of frozen soil. A white nylon material with higher tenacity is selected as a section bar, and an integrated main body structure of the six-dimensional strain sensor shown in FIG. 1 is manufactured through a 3D printing technology, including the bracket 1, the circular disc 2, the hollow cylindrical tube 3, and the base 10. The circular disc 2 has a diameter of 5 mm and a height of 3 mm. A distance between two circular discs 2 is 25 mm. A diameter of a hollow hole of the hollow cylindrical tube 3 is 1 mm. The cylindrical encapsulation structure 8 is also manufactured through 3D printing, is made of the white nylon material, and also has a hole diameter of 1 mm.

A first FBG 4 of seven cascaded FBGs 4 is encapsulated in the cylindrical encapsulation structure 8 by using epoxy resin, and is placed into the cavity 7 inside the base 10, and the cavity 7 is sealed by the cover plate 6 to form a temperature sensing unit of the FBGs-based six-dimensional strain sensor. The rest of FBGs 4 are sequentially encapsulated into corresponding hollow cylindrical tubes 3 by using the epoxy resin in a sequence of Z, XZ, X, XY, Y, and YZ, and finally the optical fiber is guided out from an inner end of the hollow cylindrical tube 3 in the YZ direction as a transmission line for a sensing signal during measurement.

The finally designed FBGs-based six-dimensional strain sensor is capable of converting strains in the six spatial directions of X, Y, Z, XY, XZ, and YZ inside the measured object into changes of center wavelength values (λ_{FBG}) corresponding to the cascaded FBGs of the FBGs-based six-dimensional strain sensor to implement measurement of the spatial principal strain. The principle is as follows.

Influences of a temperature and a strain on λ_{FBG} are independent and linear (as shown in formula 1),

$$Δ {λ}_{FBG} = {k}_{T} Δ T + {k}_{ε} Δε \qquad ( 1 )$$

k_{T} indicates a temperature coefficient of a FBG, k_{ε} indicates a strain coefficient of the FBG, ΔT and Δε respectively indicate a variation of the temperature and a variation of the strain. Therefore, a temperature of the measured object can be calculated according to a center wavelength offset of the temperature sensing unit in the sensor, to eliminate center wavelength offsets, caused by the temperature, of the strain sensing units in the six directions, so as to implement temperature compensation for strain measurement. Strains (εₓ, ε_{y}, ε_{z}, ε_{xy}, ε_{xz}, ε_{yz}) in the six spatial directions of X, Y, Z, XY, XZ, and YZ, can be obtained according to changes of center wavelengths of seven cascaded FBGs in the sensing apparatus, as shown in formula (2), where T₀ and ε₀ are initial values of the temperature and the strain. Formula (2) is a mathematical model designed for the FBGs-based six-dimensional strain sensor.

$$[ \begin{matrix}{ε}_{x} \\ {ε}_{y} \\ {ε}_{𝓏} \\ {ε}_{xy} \\ {ε}_{x 𝓏} \\ {ε}_{y 𝓏} \\ T\end{matrix} ] = [ \begin{matrix}{k}_{ε x}^{- 1} & 0 & 0 & 0 & 0 & 0 & - {{k}_{Tx} ( {k}_{T} {k}_{ε x} )}^{- 1} \\ 0 & {k}_{ε y}^{- 1} & 0 & 0 & 0 & 0 & - {{k}_{Ty} ( {k}_{T} {k}_{ε y} )}^{- 1} \\ 0 & 0 & {k}_{ε 𝓏}^{- 1} & 0 & 0 & 0 & - {{k}_{T 𝓏} ( {k}_{T} {k}_{ε 𝓏} )}^{- 1} \\ 0 & 0 & 0 & {k}_{ε xy}^{- 1} & 0 & 0 & - {{k}_{Txy} ( {k}_{T} {k}_{ε xy} )}^{- 1} \\ 0 & 0 & 0 & 0 & {k}_{ε y 𝓏}^{- 1} & 0 & - {{k}_{Tx 𝓏} ( {k}_{T} {k}_{ε x 𝓏} )}^{- 1} \\ 0 & 0 & 0 & 0 & 0 & {k}_{ε y 𝓏}^{- 1} & - {{k}_{Tx 𝓏} ( {k}_{T} {k}_{ε x 𝓏} )}^{- 1} \\ 0 & 0 & 0 & 0 & 0 & 0 & {k}_{T}\end{matrix} ] [ \begin{matrix}{Δλ}_{x} \\ {Δλ}_{y} \\ {Δλ}_{𝓏} \\ {Δλ}_{xy} \\ {Δλ}_{x 𝓏} \\ {Δλ}_{y 𝓏} \\ {Δλ}_{T}\end{matrix} ] + [ \begin{matrix}{ε}_{x 0} \\ {ε}_{y 0} \\ {ε}_{𝓏 0} \\ {ε}_{xy 0} \\ {ε}_{x 𝓏 0} \\ {ε}_{y 𝓏 0} \\ {T}_{0}\end{matrix} ] \qquad ( 2 )$$

A group of strain values, measured by the sensing apparatus, in the six directions are substituted into a formula (3) to obtain six basic strain components (εₓ, ε_{y}, ε_{z}, ε_{xy}, ε_{yz}, ε_{xz}) that indicate spatial strains.

$${γ}_{xy} = 2 {ε}_{xy} - {ε}_{x} - {ε}_{y} \qquad ( 3 )$$

$${γ}_{y 𝓏} = 2 {ε}_{y 𝓏} - {ε}_{y} - {ε}_{𝓏}$$

$${γ}_{𝓏 x} = 2 {ε}_{𝓏 x} - {ε}_{𝓏} - {ε}_{x}$$

γ_{xy}, γ_{yz}, and γ_{zx} respectively indicate spatial shear strains in an XY plane, a YZ plane, and a ZX plane. A normal strain and a shear strain of a measured point on any section can be obtained through the six basic strain components. Therefore, a strain state, in three-dimensional space, of the point can be completely determined through the six strain components. The strain components are substituted into a spatial principal strain equation (4).

$${ε}^{3} - {I}_{1} {ε}^{2} + {I}_{2} ε - {I}_{3} = 0 \qquad ( 4 )$$

I₁, I₂, and I₃ in the formula (4) are respectively a first invariant, a second invariant, and a third invariant of a strain tensor, which can be calculated according to the formula (5).

$${I}_{1} = {ε}_{x} + {ε}_{y} + {ε}_{𝓏} \qquad ( 5 )$$

$${I}_{2} = {ε}_{y} {ε}_{𝓏} + {ε}_{𝓏} {ε}_{x} + {ε}_{x} {ε}_{y} - \frac{{γ}_{𝓏 x}^{2} + {γ}_{y 𝓏}^{2} + {γ}_{xy}^{2}}{4}$$

$${I}_{3} = {ε}_{x} {ε}_{y} {ε}_{𝓏} - \frac{{ε}_{x} {γ}_{y 𝓏}^{2} + {ε}_{y} {γ}_{𝓏 x}^{2} + {ε}_{𝓏} {γ}_{xy}^{2}}{4} + \frac{{γ}_{xy} {γ}_{y 𝓏} {γ}_{𝓏 x}}{4}$$

The spatial principal strain equation (4) is resolved according to the formula (5), so that sizes of a first principal strain ε₁, a second principal strain ε₂, and a third strain ε₃ can be obtained. A principal strain direction cosine equation set (6) is introduced to determine a direction of the principal strain.

$$\{ \begin{matrix}2 ( {ε}_{x} - {ε}_{i} ) l + {γ}_{xy} m + {γ}_{𝓏 x} n = 0 \\ {γ}_{xy} l + 2 ( {ε}_{y} - {ε}_{i} ) m + {γ}_{y 𝓏} n = 0 \\ {γ}_{𝓏 x} l + {γ}_{y 𝓏} m + 2 ( {ε}_{z} - {ε}_{i} ) n = 0\end{matrix} \qquad ( 6 )$$

ε₁, ε₂m and ε₃ are sequentially substituted into εᵢ in the formula (6) to obtain direction cosine values l, m and n of included angles between the principal strains and three coordinate axes: X, Y, and Z, which satisfy the following relationship:

$${l}^{2} + {m}^{2} + {n}^{2} = 1 \qquad ( 7 )$$

According to the cosine values of the principal strain on the coordinate axes, an angle between the principal strain and each coordinate axis can be calculated according to formula (7), where θ_{X} indicates an included with the X-axis, θ_{Y} indicates an included angle with the Y-axis, and θ_{Z} indicates an included angle with the Z-axis. A principal strain distribution status in the three-dimensional space can be finally determined according to a size and direction of the principal strain.

$${θ}_{X} = arccos l l ∈ [ - 1 , 1 ] \qquad ( 8 )$$

$${θ}_{Y} = arccos m m ∈ [ - 1 , 1 ]$$

$${θ}_{Z} = arccos n n ∈ [ - 1 , 1 ]$$

A measurement mutual interference problem among six sensing spatial directions should be considered during measurement, to improve strain sensing precision of a multidimensional strain sensing apparatus. Therefore, a multidimensional strain decoupling apparatus and method is designed on the basis of the FBGs-based six-dimensional strain sensor. Details are as follows.

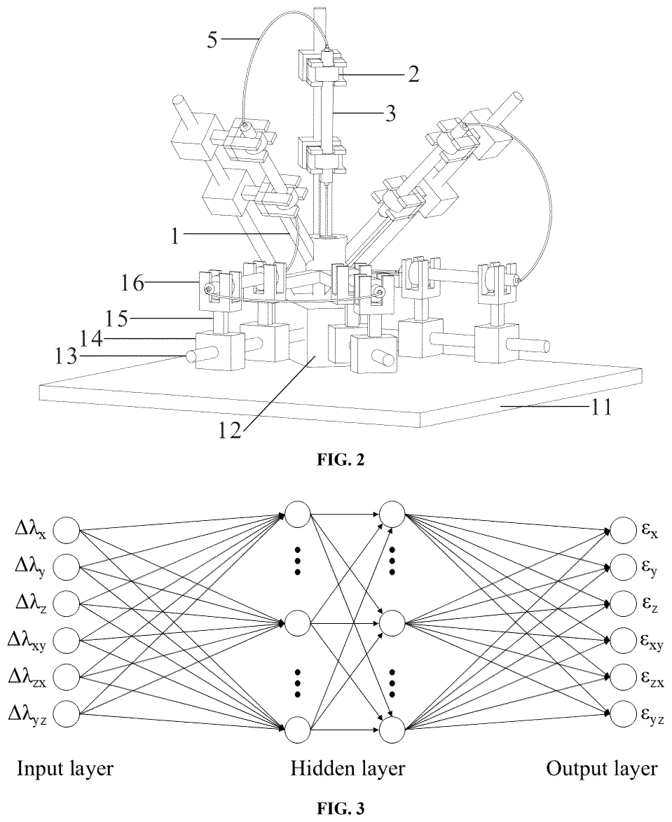

As shown in FIG. 2, a multidirectional strain decoupling calibration apparatus is configured to: fix the FBGs-based six-dimensional strain sensor, and perform multidirectional strain calibration on strain sensing units in the six directions of the FBGs-based six-dimensional strain sensor. The multidirectional strain decoupling calibration apparatus includes a fixed plate 11 on a bottom, a micro-displacement electric control box 12, calibration shafts 13, movable sliding blocks 14, connection rods 15, and fixtures 16. The fixed plate 11 serves as a base of the entire decoupling calibration apparatus, and does not move in a use process, to reduce an error caused by shake of the apparatus in the decoupling calibration process. The micro-displacement electric control box 12 is tightly fixed with the fixed plate 11 through a screw, and is connected to the calibration shafts 13 arranged in the six directions. Two movable sliding blocks 14 are disposed on each calibration shaft 13, and each movable block 14 is capable of independently moving along the calibration shafts 13 under control of the micro-displacement electric control box 12. One connection rod 15 is provided on each movable sliding block 14, and the fixture 16 is fixed on the movable sliding block 14 and is capable of moving along the calibration shaft 13. Circular discs 2 of the strain sensing unit in each direction of the FBGs-based six-dimensional strain sensor are placed into the fixtures 16 in corresponding directions, and the strain sensing units in the six directions are fixed via the fixtures 16; and in a multidirectional strain decoupling calibration process, the circular discs 2 in the FBGs-based six-dimensional strain sensor are driven by the fixtures 16 to move, so as to apply a displacement load to the strain sensing units.

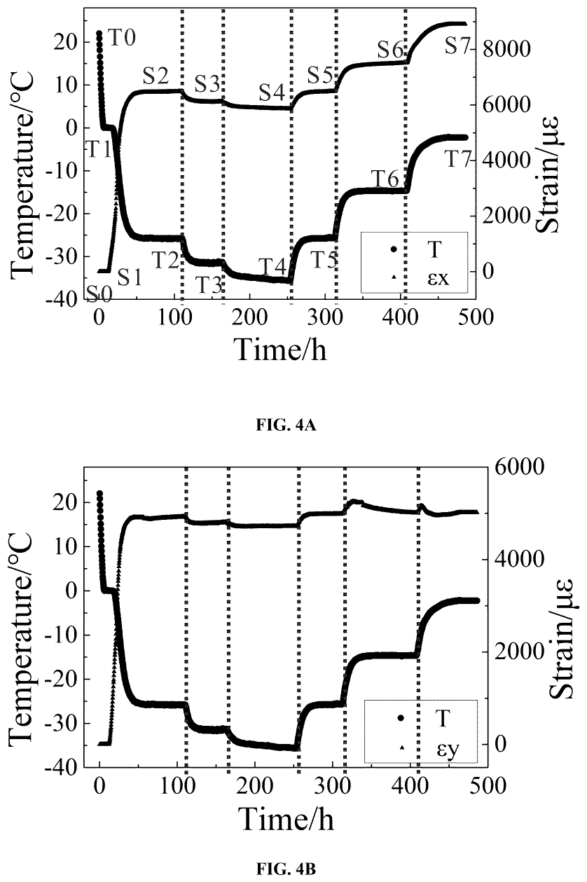

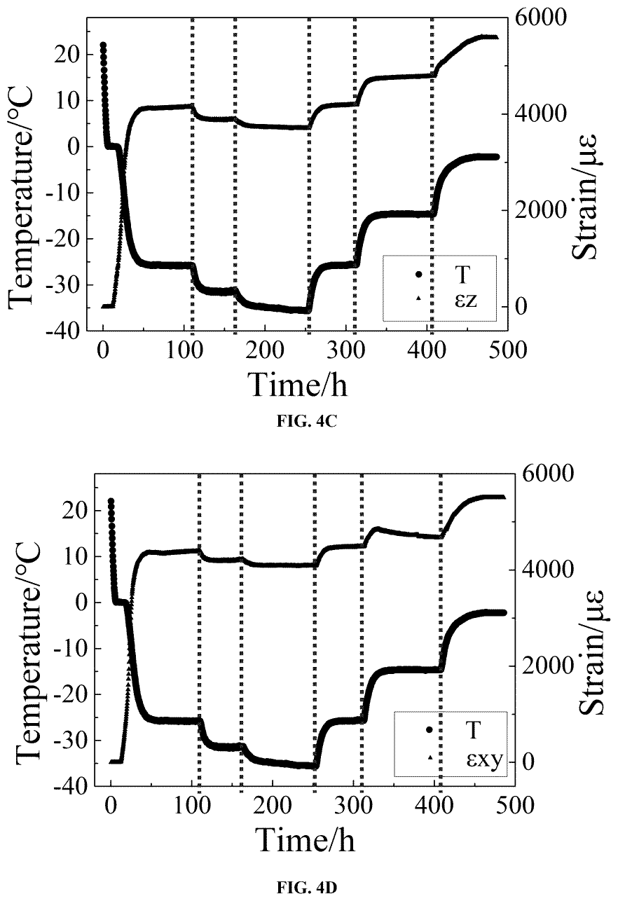

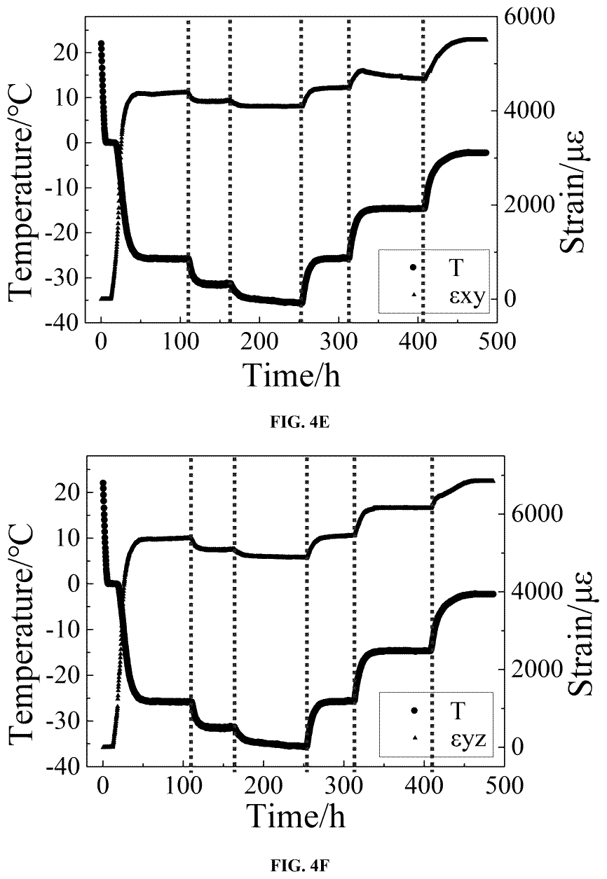

The micro-displacement electric control box 12 is a central control part in the entire calibration decoupling apparatus, and is capable of independently controlling the fixture 16 in each direction to move, and the fixture 16 has a compressing or stretching displacement under control of the micro-displacement electric control box 12, or is in a free state without force; and therefore, complex strains in a plurality of spatial directions are simulated. Multidirectional strain calibration experiment is performed on the FBGs-based six-dimensional strain sensor via the multidimensional strain decoupling calibration apparatus to obtain complete calibration data (a strain of the sensing unit and a center wavelength offset of the FBG 4), and the complete calibration data is substituted into a BP-neural network algorithm to implement multidimensional strain decoupling of the FBGs-based six-dimensional strain sensor. The spatial complex strain inside the frozen soil is measured via the manufactured FBGs-based six-dimensional strain sensor, as shown in FIGS. 4A-4F. T0 to T7 indicate temperatures, measured by the temperature sensing unit of the FBGs-based six-dimensional strain sensor during measurement, inside the frozen soil, and S0 to S7 indicate strains. Temperature and strain changes inside the frozen soil can be seen from FIGS. 4A-4F. Strain tendencies in the six directions are basically the same, and are in positive correlation with a temperature after the frozen soil is completely frozen. In a freezing soil of moisture-containing soil, the temperature decreases from T0 to T2. A phase change from water to ice leads to volume increase, and therefore, the moisture-containing soil expands (S0 to S2) in all of the six directions. Maximum freezing expansion in the X direction, measured by the sensor, of the frozen soil is 6471.38 μs. After the soil is completely frozen, an ambient temperature gradually changes to T7 from T2, and the strain is to be stable (S2 to S7).

A multidimensional strain decoupling method is implemented based on the calibration apparatus, and specifically includes the following steps.

In a first step, an FBGs-based six-dimensional strain sensor is fixed on the decoupling apparatus shown in FIG. 2, and a circular disc 2 is placed into a fixture 16 in a corresponding direction for moving along with the fixture 16 to deform. The decoupling fixture 16 is controlled to apply a stretching strain and a compressing strain to a sensing unit in an X direction in the FBGs-based six-dimensional strain sensor, and the straining strain and the compressing strain are recorded as T_{X} and C_{X}. In the entire calibration process, when the stretching strain (T_{X}) is applied, a strain range is 0με to 5000με, and an interval for applying the strain is 500με. When the compressing strain (C_{X}) is applied, a strain range is −5000με to 0με, and an interval for applying the strain is 500με.

In a second step, a single strain sensing unit of a six-dimensional strain sensor is calibrated as follows.

Two fixtures 16 in the X direction are controlled to drive two circular discs 2 on the sensing unit to move, and fixtures in other five directions do not move, so that strain sensing units in a Y direction, a Z direction, an XY direction, an XZ direction, and a YZ direction are in a free state without force. The two fixtures 16 in the X direction are controlled by a micro-displacement electric control box 12 to get close to each other and the compressing strain (C_{X}) is applied to the strain sensing unit in the X direction, and then the fixtures 16 are made to be away from each other and the stretching strain (T_{X}) is applied to the strain sensing unit in the X direction, where there are 2 calibration combinations in total; and strain values applied to the strain sensing units in the six directions and offsets of center wavelengths of FBGs 4 of the strain sensing units in the six directions in the process are recorded.

Similarly, a single strain sensing unit in each of other five directions is sequentially calibrated, and corresponding calibration data is obtained. Calibration data of all single strain sensing units are recorded as S1, where there are 12 calibration combinations.

In a third step, two strain sensing units of the six-dimensional strain sensor are calibrated as follows.

Fixtures 16 in the X and Y directions on the decoupling apparatus are controlled to drive circular discs 2 on the strain sensing units in the X and Y directions, and strains are applied to the strain sensing units in the X and Y directions of the FBGs-based six-dimensional strain sensor, so that strain sensing units in other directions are in a free state without external force. A strain applying sequence is as follows: C_{X}-C_{Y} (that is, the sensing unit in the X direction of the FBGs-based six-dimensional strain sensor is compressed while the sensing unit in the Y direction is compressed), C_{X}-T_{Y}, T_{Y}-C_{Y}, and T_{Y}-T_{Y}, where there are 4 calibration combinations in total. Strain values applied to the strain sensing units in the six directions and offsets of center wavelengths of FBGs 4 of the strain sensing units in the six directions in the entire process are simultaneously recorded, to obtain center wavelength response rules of the FBGs 4 of the six sensing units of the FBGs-based six-dimensional strain sensor when the sensing units in the X and Y directions are simultaneously strained.

Similarly, cases in which two strain sensing units in each of other fourteen groups of directions in total: X-Z, X-XY, X-XZ, X-YZ, Y-Z, Y-XY, Y-XZ, Y-YZ, Z-XY, Z-XZ, Z-YZ, XY-XZ, XY-YZ, and XZ-YZ, are simultaneously strained are sequentially calibrated. Calibration data of all of every two strain sensing units are recorded as S2, where there are 60 calibration combinations.

In a fourth step, three strain sensing units of the six-dimensional strain sensor are simultaneously calibrated as follows.

Strains are simultaneously applied to the strain sensing units in the X, Y, and Z directions by using the fixtures 16 of the decoupling apparatus in a sequence of C_{X}-C_{Y}-C_{Z}, C_{X}-C_{Y}-T_{Z}, C_{X}-T_{Y}-C_{Z}, C_{X}-T_{Y}-T_{Z}, T_{X}-C_{Y}-C_{Z}, T_{X}-C_{Y}-T_{Z}, T_{X}-T_{Y}-C_{Z}, and T_{X}-T_{Y}-T_{Z}, where there are 8 calibration combinations in total. Strain values applied to the strain sensing units in the six directions and offsets of center wavelengths of FBGs 4 of the strain sensing units in the six directions in the entire process are simultaneously recorded, to obtain center wavelength response rules of the FBGs 4 of the six sensing units of the FBGs-based six-dimensional strain sensor when the sensing units in the X, Y, and Z directions are simultaneously strained.

Similarly, strains are simultaneously applied to strain sensing units in twenty groups of directions in total: X-Y-XY, X-Y-XZ, X-Y-YZ, Y-Z-XY, Y-Z-XZ, Y-Z-YZ, Z-XY-XZ, Z-XY-YZ, . . . , XY-XZ-YZ in sequence. Calibration data when all of every three strain sensing units are simultaneously strained are recorded as S3, where there are 160 calibration combinations.

In a fifth step, four strain sensing units of the six-dimensional strain sensor are simultaneously calibrated as follows.

Strains are simultaneously applied to the strain sensing units in the X, Y, Z, and XY directions by using the fixtures 16 of the decoupling apparatus in a sequence of C_{X}-C_{Y}-C_{Z}-C_{XY}, C_{X}-C_{Y}-C_{Z}-T_{XY}, C_{X}-C_{Y}-T_{Z}-C_{XY}, C_{X}-C_{Y}-T_{Z}-T_{XY}, C_{X}-T_{Y}-C_{Z}-C_{XY}, C_{X}-T_{Y}-C_{Z}-T_{XY}, C_{X}-C_{Y}-T_{Z}-C_{XY}, C_{X}-C_{Y}-T_{Z}-T_{XY}, T_{X}-C_{Y}-C_{Z}-C_{XY}, T_{X}-C_{Y}-C_{Z}-T_{XY}, T_{X}-C_{Y}-T_{Z}-C_{XY}, T_{X}-C_{Y}-T_{Z}-T_{XY}, T_{X}-T_{Y}-C_{Z}-C_{XY}, T_{X}-T_{Y}-C_{Z}-T_{XY}, T_{X}-C_{Y}-T_{Z}-C_{XY}, and T_{X}-C_{Y}-T_{Z}-T_{XY}, where there are 16 calibration combinations in total; and strain values applied to the strain sensing units in the six directions and offsets of center wavelengths of FBGs 4 of the strain sensing units in the six directions in the entire process are recorded, to obtain center wavelength response rules of the FBGs 4 of the six sensing units of the FBGs-based six-dimensional strain sensor when the sensing units in the X, Y, Z, and XY directions are simultaneously strained.

Similarly, strains are simultaneously applied to strain sensing units in fifteen groups of directions in total: X-Y-Z-XZ, X-Y-Z-YZ, Y-Z-XY-XZ, Y-Z-XY-YZ, . . . , and Z-XY-XZ-YZ in sequence. Calibration data when all of every four strain sensing units are simultaneously strained are recorded as S4, where there are 240 calibration combinations.

In a sixth step, five strain sensing units of the six-dimensional strain sensor are simultaneously calibrated as follows.

Strains are simultaneously applied to the strain sensing units in the X, Y, Z, XY, and XZ directions by using the fixtures 16 of the decoupling apparatus in a sequence of C_{X}-C_{Y}-C_{Z}-C_{XY}-C_{XZ}, C_{X}-C_{Y}-C_{Z}-C_{XY}-T_{XZ}, . . . , T_{X}-T_{Y}-T_{Z}-T_{XY}-T_{X}, where there are 32 calibration combinations in total; and strain values applied to the strain sensing units in the six directions and offsets of center wavelengths of FBGs 4 of the strain sensing units in the six directions in the entire process are recorded, to obtain center wavelength response rules of the FBGs 4 of the six sensing units of the FBGs-based six-dimensional strain sensor when the sensing units in the X, Y, Z, XY, and XZ directions are simultaneously strained.

Similarly, strains are simultaneously applied to strain sensing units in five groups of directions in total: Y-Z-XY-XZ-YZ, Z-XY-XZ-YZ-X, XY-XZ-YZ-X-Y, XZ-YZ-X-Y-Z, and YZ-X-Y-Z-XY. Calibration data when all of every five strain sensing units are simultaneously strained are recorded as S5, where there are 192 calibration combinations.

In a seventh step, six strain sensing units of the six-dimensional strain sensor are simultaneously calibrated as follows.

Strains are simultaneously applied to the strain sensing units in the X, Y, Z, XY, and XZ directions by using the fixtures 16 of the decoupling apparatus in a sequence of C_{X}-C_{Y}-C_{Z}-C_{XY}-C_{XZ}-C_{YZ}, C_{X}-C_{Y}-C_{Z}-C_{XY}-C_{XZ}-T_{YZ}, . . . , C_{X}-T_{Y}-T_{Z}-T_{XY}-T_{XZ}-T_{YZ}, and T_{X}-T_{Y}-T_{Z}-T_{XY}-T_{XZ}-T_{YZ}, where there are 64 calibration combinations in total; and strain values applied to the strain sensing units in the six directions and offsets of center wavelengths of FBGs 4 of the strain sensing units in the six directions in the entire process are recorded, to obtain center wavelength response rules of the FBGs 4 of the six sensing units of the FBGs-based six-dimensional strain sensor when the sensing units in the X, Y, Z, XY, and XZ directions are simultaneously strained. Calibration data when all of every five strain sensing units are strained are simultaneously recorded as S6, where there are 64 calibration combinations.

In an eighth step, after multidirectional strain calibration is completed, 728 calibration combinations in total are obtained for calibration data (S1, S2, S3, S4, S5, and S6). Each calibration combination includes strains applied to the six strain sensing units and center wavelength values of FBGs 4 in the six strain sensing units. Model training is performed by taking center wavelengths of the six FBGs 4 as input (Δλx, Δλy, Δλz, Δλxy, Δλxz, Δλyz), and taking strains applied to the six strain sensing units as output (εx, εy, εz, εxy, εxz, εyz), and substituting the input and the output into a BP-neural network algorithm, to obtain a sensor strain decoupling model based on a BP-neural network.

After the sensor strain decoupling model is obtained, a sensing signal (Δλₓ, Δλ_{y}, Δλ_{z}, Δλ_{xy}, Δλ_{xz}, Δλ_{yz}) of the FBGs-based six-dimensional strain sensor is substituted into the decoupling model when a spatial strain value is measured by the six-dimensional strain sensor, to obtain a more accurate decoupled spatial strain (εₓ, ε_{y}, ε_{z}, ε_{xy}, ε_{xz}, ε_{yz}) of a measured object in each direction at this moment.

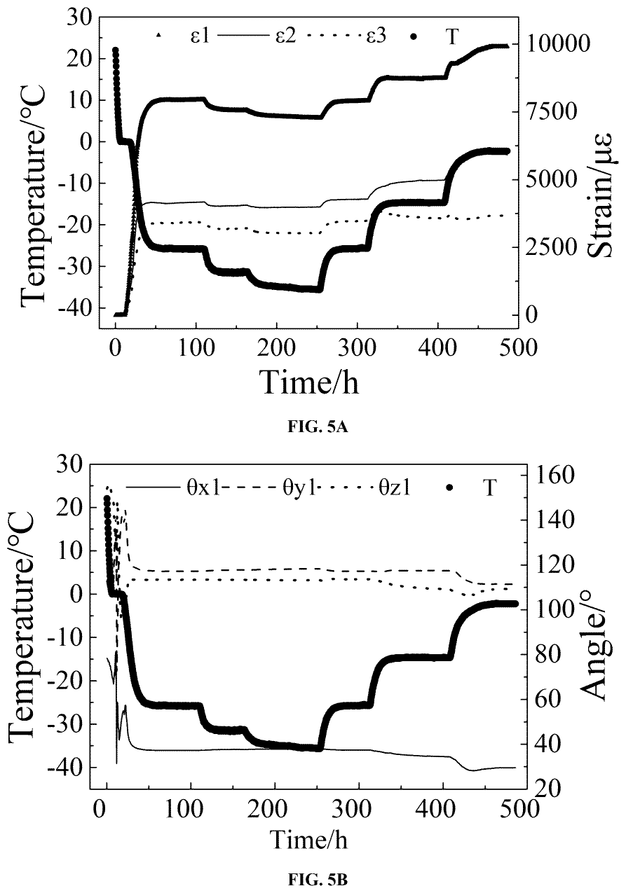

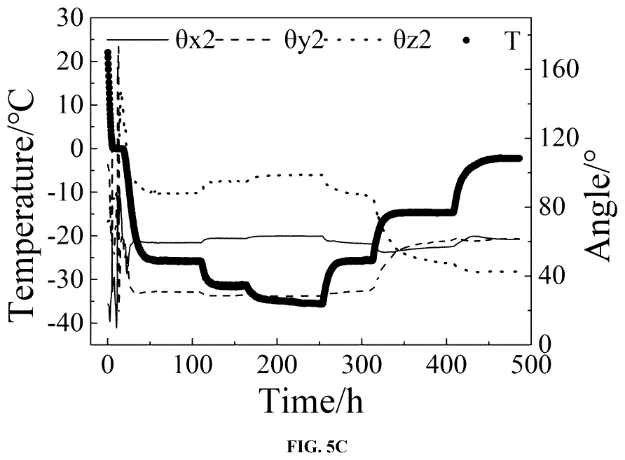

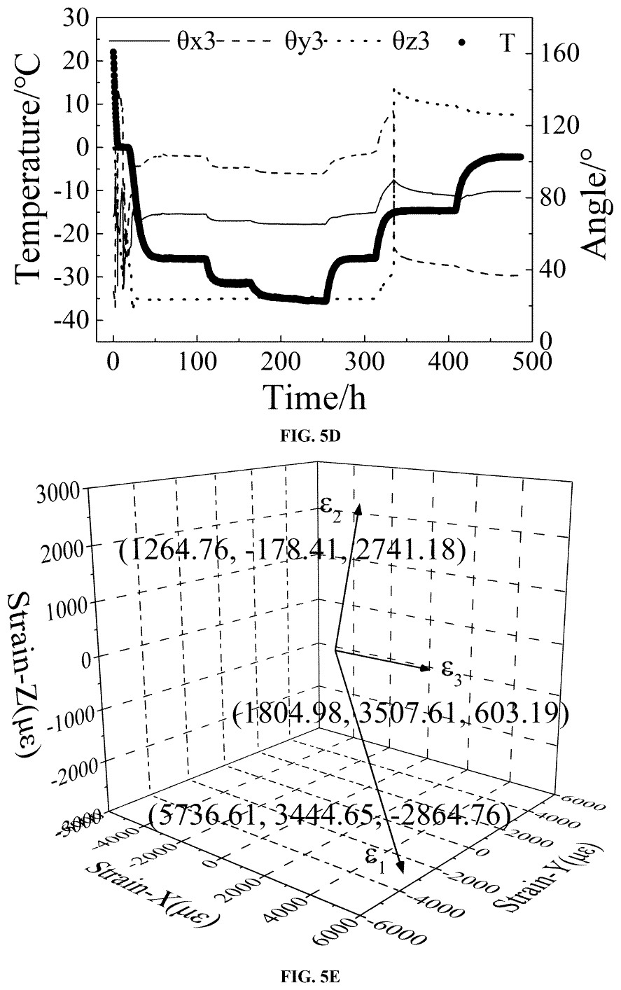

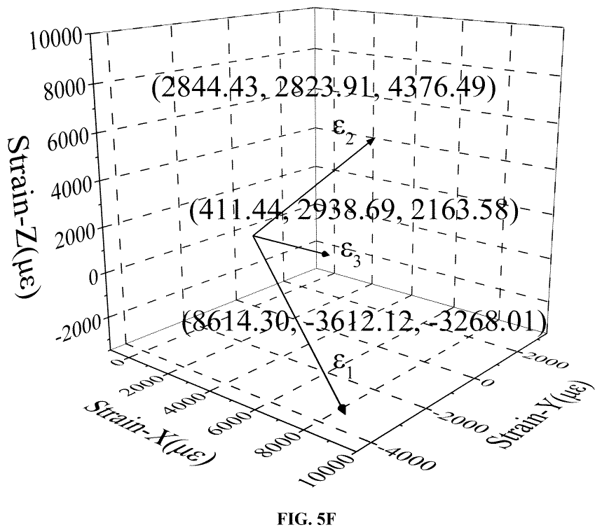

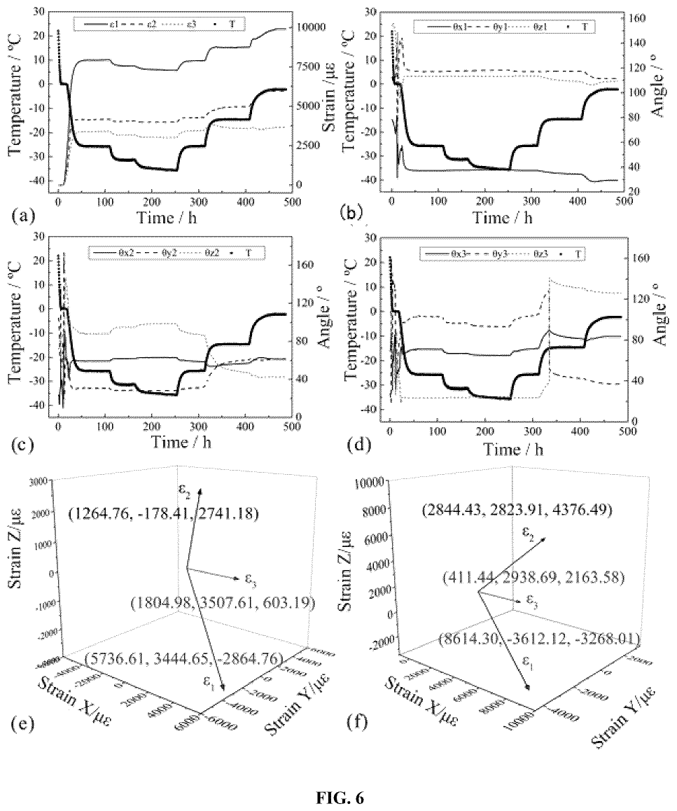

The measured strains (εₓ, ε_{y}, ε_{z}, ε_{xy}, ε_{xz}, ε_{yz}) in six directions inside the frozen soil are substituted into the formulas (3 to 8) to obtain a size of the principal strain and a spatial distribution status, as shown in FIGS. 5A-5F. In the FIG. 5A, sizes of three principal strains are basically relevant to the temperature. At an initial completely-frozen stage (T2, S2), a first principal strain is ε₁=7925.84με. In the entire experimental process, a maximum value of the first principal strain is 9896.15με. Angles between the principal strains (εᵢ, i=1, 2, 3) and the X, Y, and Z directions are respectively θ_{Xi}, θ_{Yi}, θ_{Zi} (FIG. 5B to FIG. 5D). θ_{X1} is basically kept unchanged, indicating that a main deformation direction of the frozen soil is basically kept unchanged. In FIG. 5E and FIG. 5F, when a lowest temperature and a highest strain are selected, the principal strain inside the frozen soil is indicated in the three-dimensional space coordinate system.

The foregoing embodiments are merely implementations of the present disclosure, and should not be understood as limitations to the range of the present disclosure, and it should be noted that various modifications and variations can be made by those skilled in the art without departing from the conception of the present disclosure and are within the scope of the present disclosure.

1. A fiber Bragg gratings (FBGs)-based six-dimensional strain sensor for monitoring a spatial principal strain, wherein the FBGs-based six-dimensional strain sensor has six strain sensing units of a same structure that are arranged in six spatial directions of X, Y, Z, XY, XZ, and YZ, and also has a temperature sensing unit arranged inside a base of the FBGs-based six-dimensional strain sensor to achieve temperature compensation in a strain measurement process of the FBGs-based six-dimensional strain sensor; and the FBGs-based six-dimensional strain sensor is capable of converting strains in the six spatial directions of X, Y, Z, XY, XZ, and YZ inside a measured object into changes of center wavelength values corresponding to cascaded FBGs of the FBGs-based six-dimensional strain sensor to implement measurement of the spatial principal strain.

2. The FBGs-based six-dimensional strain sensor for monitoring a spatial principal strain according to claim 1, wherein the FBGs-based six-dimensional strain sensor is specifically as follows:
the FBGs-based six-dimensional strain sensor comprises a bracket (1), the base (10), the six strain sensing units that are respectively disposed in the six directions and have a same structure, the temperature sensing unit, optical fibers (5), a cylindrical encapsulation structure (8), and a temperature FBG (9), wherein each of the six strain sensing units comprises a hollow cylindrical tube (3), strain FBGs (4), and two circular discs (2); and the temperature sensing unit comprises a cover plate (6), a cylindrical cavity (7), and the cylindrical encapsulation structure (8);
the bracket (1) is configured to support the six strain sensing units in the six spatial directions, and bottoms of the six strain sensing units are fixed to the base (10); the strain FBG (4) is located in a center of the hollow cylindrical tube (3), and is fixed with an inner wall of the tube by using a fixative; the two circular discs (2) are arranged on an outer wall surface of the hollow cylindrical tube (3), and the circular disc (2) is configured to prevent sliding relative to the measured object in a measurement process; the base (10) is of a hollow cylindrical structure, and is internally nested with a coaxial hollow circular tube, the cylindrical encapsulation structure (8) and the temperature FBG (9) are disposed in the circular tube, the cover plate (6) is disposed on a top of the circular tube, a through hole for allowing the strain FBG (4) to pass through is formed in a middle of the cover plate, and the strain FBG (4) is connected to the temperature FBG (9); and the cylindrical cavity (7) is provided between the cylindrical encapsulation structure (8) and the cover plate (6), and the six strain FBGs (4) and one temperature FBG (9) are cascaded together and are arranged in the FBGs-based six-dimensional strain sensor in sequence; and the one temperature FBG (9) is arranged in a cavity of the base (10), to eliminate temperature interference in the measurement process; and the temperature FBG (9) is only affected by a temperature and is not affected by deformation of an external sensing apparatus, and is configured to perform temperature compensation as the temperature sensing unit.

3. The FBGs-based six-dimensional strain sensor for monitoring a spatial principal strain according to claim 2, wherein the six strain FBGs (4) and the one temperature FBG (9) are arranged as follows:
one end that is of the hollow cylindrical tube (3) and that is close to the base (10) is defined as an inner end, and the other end of the hollow cylindrical tube (3) is defined as an outer end; a first FBG gets in from the outer end of the hollow cylindrical tube (3) in the YZ direction and is fixed in the hollow cylindrical tube (3) in the YZ direction; after the first FBG (4) is fixed, an optical fiber guided out from the outer end of the hollow cylindrical tube (3) in the YZ direction gets in the hollow cylindrical tube (3) in the Y direction, and a second FBG (4) is fixed in the hollow cylindrical tube (3) in the Y direction; an optical fiber guided out from the inner end of the hollow cylindrical tube (3) in the Y direction gets in from the inner end of the hollow cylindrical tube (3) in the XY direction, and a third FBG (4) is fixed in the hollow cylindrical tube (3) in the XY direction; an optical fiber guided out from the outer end of the hollow cylindrical tube (3) in the XY direction gets in from the outer end of the hollow cylindrical tube (3) in the X direction, and a fourth FBG (4) is fixed in the hollow cylindrical tube (3) in the X direction; an optical fiber guided out from the inner end of the hollow cylindrical tube (3) in the X direction gets in from the inner end of the hollow cylindrical tube (3) in the XZ direction, and a fifth FBG (4) is fixed in the hollow cylindrical tube (3) in the XZ direction; an optical fiber guided out from the outer end of the hollow cylindrical tube (3) in the XZ direction gets in from the outer end of the hollow cylindrical tube (3) in the Z direction, and a sixth FBG (4) is fixed in the hollow cylindrical tube (3) in the Z direction; and an optical fiber (a tail end of which is provided with the temperature FBG (9)) guided out from an inner end of the hollow cylindrical tube (3) in the Z direction gets into the cavity (7) of the base (10), thereby completing arrangement of the six strain FBGs (4) and the one temperature FBG (9).

4. The FBGs-based six-dimensional strain sensor for monitoring a spatial principal strain according to claim 2, wherein the temperature sensing unit is arranged in the cylindrical cavity (7) of the base (10), specifically as follows:
a FBG fiber (4) fixed on an optical fiber guided out from the inner end of the hollow cylindrical tube (3) in the Z direction passes through the circular cover plate (6) with a hole, and then is fixed in the cylindrical encapsulation structure (8); a diameter of the cylindrical encapsulation structure (8) is less than a diameter of the cavity (7) in which a hollow groove for allowing the optical fiber to pass through is provided; and the cylindrical encapsulation structure (8) in which the FBG (4) is fixed is placed in the cavity (7), and the cavity is sealed via the cover plate (6), making the encapsulated temperature FBG (9) in the cavity only affected by a temperature and not affected by external force, to finally form the temperature sensing unit of the FBGs-based six-dimensional strain sensor.

5. A multidirectional strain decoupling calibration apparatus, wherein the calibration apparatus is configured to: fix the FBGs-based six-dimensional strain sensor for monitoring a spatial principal strain according to claim 1, and perform multidirectional strain calibration on strain sensing units in the six directions of the FBGs-based six-dimensional strain sensor, specifically as follows:
the multidirectional strain decoupling calibration apparatus comprises a fixed plate (11) on a bottom, a micro-displacement electric control box (12), calibration shafts (13), movable sliding blocks (14), connection rods (15), and fixtures (16); the fixed plate (11) serves as a base of the decoupling calibration apparatus, and does not move in a use process; the micro-displacement electric control box (12) is fixedly connected to the fixed plate (11), and is connected to the calibration shafts (13) arranged in the six directions; two movable sliding blocks (14) are disposed on each calibration shaft (13), and each movable sliding block (14) is capable of independently moving along the calibration shafts (13) under control of the micro-displacement electric control box (12); one connection rod (15) is provided on each movable sliding block (14), and the fixture (16) is fixed on the movable sliding block (14) and is capable of moving along the calibration shaft (13) with the movable sliding block (14); and circular discs (2) of the strain sensing unit in each direction of the six-dimensional strain sensing apparatus are placed into the fixtures (16), and the strain sensing units in the six directions are fixed via the fixtures (16); and
in a multidirectional strain decoupling calibration process, the circular discs (2) in the FBGs-based six-dimensional strain sensor are driven by the fixtures (16) to move, so as to apply a displacement load to the strain sensing units.

6. The multidirectional strain decoupling calibration apparatus according to claim 5, wherein the micro-displacement electric control box (12) is a central control part in the entire decoupling calibration apparatus, and is capable of independently controlling the fixture (16) in each direction to move, and the fixture (16) has a compressing or stretching displacement under control of the micro-displacement electric control box (12), or is in a free state without force; and therefore complex strains in a plurality of spatial directions are simulated.

7. A multidirectional strain decoupling method, wherein the multidirectional strain decoupling method is implemented based on the calibration apparatus according to claim 5, and comprises the following steps:
a first step, fixing an FBGs-based six-dimensional strain sensor on the calibration apparatus, placing a circular disc (2) into a fixture (16) in a corresponding direction, and controlling the decoupling fixture (16) to apply a stretching strain and a compressing strain to a sensing unit in an X direction in the six-dimensional strain sensing apparatus, and recording the straining strain and the compressing strain as T_{X}and C_{X};
a second step, calibrating a single strain sensing unit of a six-dimensional strain sensor:
controlling two fixtures (16) in the X direction to drive two circular discs (2) on the sensing unit to move, and fixtures (16) in other five directions not to move, making strain sensing units in a Y direction, a Z direction, an XY direction, an XZ direction, and a YZ direction in a free state without force; controlling, by a micro-displacement electric control box (12), the two fixtures (16) in the X direction to get close to each other and applying the compressing strain C_{X} to the strain sensing unit in the X direction, making the fixtures (16) away from each other and applying the stretching strain T_{X} to the strain sensing unit in the X direction, wherein there are two calibration combinations in total; and recording strain values applied to the strain sensing units in the six directions and offsets of center wavelengths of FBGs (4) of the strain sensing units in the six directions in the process; and
sequentially calibrating a single strain sensing unit in each of other five directions, and obtaining corresponding calibration data; and recording calibration data of all single strain sensing units as S1, wherein there are 12 calibration combinations;
a third step, calibrating two strain sensing units of the six-dimensional strain sensor:
controlling fixtures (16) in the X and Y directions to drive circular discs (2) on the strain sensing units in the X and Y directions, and simultaneously applying strains to the strain sensing units in the X and Y directions of the FBGs-based six-dimensional strain sensor, and making strain sensing units in other directions in a free state without external force, wherein a strain applying sequence is as follows: C_{X}-C_{Y}, C_{X}-T_{Y}, T_{Y}-C_{Y}, and T_{Y}-T_{Y}, four calibration combinations in total; and recording strain values applied to the strain sensing units in the six directions and offsets of center wavelengths of FBGs (4) of the strain sensing units in the six directions in the entire process, to obtain center wavelength response rules of the FBGs (4) of the six strain sensing units of the FBGs-based six-dimensional strain sensor when the sensing units in the X and Y directions are simultaneously strained; and
sequentially calibrating cases in which two strain sensing units in each of fourteen groups of directions in total: X-Z, X-XY, X-XZ, X-YZ, Y-Z, Y-XY, Y-XZ, Y-YZ, Z-XY, Z-XZ, Z-YZ, XY-XZ, XY-YZ, and XZ-YZ, are simultaneously strained, and recording calibration data when all of every two strain sensing units are simultaneously strained as S2, wherein there are 60 calibration combinations;
a fourth step, simultaneously calibrating three strain sensing units of the six-dimensional strain sensor:
simultaneously applying strains to the strain sensing units in the X, Y, and Z directions by using the fixtures (16) in a sequence of C_{X}-C_{Y}-C_{Z}, C_{X}-C_{Y}-T_{Z}, C_{X}-T_{Y}-C_{Z}, C_{X}-T_{Y}-T_{Z}, T_{X}-C_{Y}-C_{Z}, T_{X}-C_{Y}-T_{Z}, T_{X}-T_{Y}-C_{Z}, and T_{X}-T_{Y}-T_{Z}, wherein there are 8 calibration combinations in total; and recording strain values applied to the strain sensing units in the six directions and offsets of center wavelengths of FBGs (4) of the strain sensing units in the six directions in the entire process, to obtain center wavelength response rules of the FBGs (4) of the six sensing units of FBGs-based six-dimensional strain sensor when the sensing units in the X, Y and Z directions are simultaneously strained; and
simultaneously applying strains to strain sensing units in twenty groups of directions in total: X-Y-XY, X-Y-XZ, X-Y-YZ, Y-Z-XY, Y-Z-XZ, Y-Z-YZ, Z-XY-XZ, Z-XY-YZ, . . . , XY-XZ-YZ in sequence, and recording calibration data as S3 when all of every three strain sensing units are simultaneously calibrated, wherein there are 160 calibration combinations;
a fifth step, simultaneously calibrating four strain sensing units of the six-dimensional strain sensor:
simultaneously applying strains to the strain sensing units in the X, Y, Z, and XY directions by using the fixtures (16) in a sequence of C_{X}-C_{Y}-C_{Z}-C_{XY}, C_{X}-C_{Y}-C_{Z}-T_{XY}, C_{X}-C_{Y}-T_{Z}-C_{XY}, C_{X}-C_{Y}-T_{Z}-T_{XY}, C_{X}-T_{Y}-C_{Z}-C_{XY}, C_{X}-T_{Y}-C_{Z}-T_{XY}, C_{X}-C_{Y}-T_{Z}-C_{XY}, C_{X}-C_{Y}-T_{Z}-T_{XY}, T_{X}-C_{Y}-C_{Z}-C_{XY}, T_{X}-C_{Y}-C_{Z}-T_{XY}, T_{X}-C_{Y}-T_{Z}-C_{XY}, T_{X}-C_{Y}-T_{Z}-T_{XY}, T_{X}-T_{Y}-C_{Z}-C_{XY}, T_{X}-T_{Y}-C_{Z}-T_{XY}, T_{X}-C_{Y}-T_{X}-C_{XY}, and T_{X}-C_{Y}-T_{Z}-T_{XY}, wherein there are 16 calibration combinations in total; and recording strain values applied to the strain sensing units in the six directions and offsets of center wavelengths of FBGs (4) of the strain sensing units in the six directions in the entire process, to obtain center wavelength response rules of the FBGs (4) of the six sensing units of the FBGs-based six-dimensional strain sensor when the sensing units in the X, Y, Z, and XY directions are simultaneously strained; and
simultaneously applying strains to strain sensing units in fifteen groups of directions in total: X-Y-Z-XZ, X-Y-Z-YZ, Y-Z-XY-XZ, Y-Z-XY-YZ, . . . , and Z-XY-XZ-YZ, and recording calibration data as S4 when all of every four strain sensing units are simultaneously calibrated, wherein there are 240 calibration combinations;
a sixth step, simultaneously calibrating five strain sensing units of the six-dimensional strain sensor:
simultaneously applying strains to the strain sensing units in the X, Y, Z, XY, and XZ directions by using the fixtures (16) in a sequence of C_{X}-C_{Y}-C_{Z}-C_{XY}-C_{XZ}, C_{X}-C_{Y}-C_{Z}-C_{XY}-T_{XZ}, . . . , T_{X}-T_{Y}-T_{Z}-T_{XY}-T_{X}, wherein there are 32 calibration combinations in total; and
recording strain values applied to the strain sensing units in the six directions and offsets of center wavelengths of FBGs (4) of the strain sensing units in the six directions in the entire process, to obtain center wavelength response rules of the FBGs (4) of the six sensing units of the FBGs-based six-dimensional strain sensor when the sensing units in the X, Y, Z, XY, and XZ directions are simultaneously strained; and
simultaneously applying strains to strain sensing units in five groups of directions in total: Y-Z-XY-XZ-YZ, Z-XY-XZ-YZ-X, XY-XZ-YZ-X-Y, XZ-YZ-X-Y-Z, and YZ-X-Y-Z-XY, and recording calibration data as S5 when all of every five strain sensing units are simultaneously calibrated, wherein there are 192 calibration combinations;
a seventh step, simultaneously calibrating six strain sensing units of the six-dimensional strain sensor:
simultaneously applying strains to the strain sensing units in the X, Y, Z, XY, XZ, and YZ directions by using the fixtures (16) of the decoupling apparatus in a sequence of C_{X}-C_{Y}-C_{Z}-C_{XY}-C_{XZ}-C_{YZ}, C_{X}-C_{Y}-C_{Z}-C_{XY}-C_{XZ}-T_{YZ}, . . . , C_{X}-T_{Y}-T_{Z}-T_{XY}-T_{XZ}-T_{YZ}, and T_{X}-T_{Y}-T_{Z}-T_{XY}-T_{XZ}-T_{YZ}, wherein there are 64 calibration combinations in total; and recording strain values applied to the strain sensing units in the six directions and offsets of center wavelengths of FBGs (4) of the strain sensing units in the six directions in the entire process, to obtain center wavelength response rules of the FBGs (4) of the six sensing units of the FBGs-based six-dimensional strain sensor when the sensing units in the X, Y, Z, XY, and XZ directions are simultaneously strained; and recording calibration data as S6 when all of every five strain sensing units are simultaneously calibrated, wherein there are 64 calibration combinations; and
an eighth step, after multidirectional strain calibration is completed, obtaining 728 calibration combinations in total for calibration data (S1, S2, S3, S4, S5, and S6), wherein each calibration combination comprises the strains applied to the six strain sensing units and the center wavelength values of the FBGs (4) in the six strain sensing units; and performing model training by taking the center wavelengths of the six FBGs (4) as input (Δλₓ, Δλ_{y}, Δλ_{z}, Δλ_{xy}, Δλ_{xz}, Δλ_{yz}), and taking the strains applied to the six strain sensing units as output (εₓ, ε_{y}, ε_{z}, ε_{xy}, ε_{xz}, ε_{yz}), to obtain a sensor strain decoupling model based on a BP-neural network; and
after obtaining the sensor strain decoupling model, substituting a sensing signal (Δλₓ, Δλ_{y}, Δ_{λz}, Δλ_{xy}, Δλ_{xz}, Δλ_{yz}) of the FBGs-based six-dimensional strain sensor at a specific moment into the sensor strain decoupling model, to obtain a more accurate decoupled spatial strain (εₓ, ε_{y}, ε_{z}, ε_{xy}, ε_{xz}, ε_{yz}) of a measured object in each direction at the specific moment.

8. The multidirectional strain decoupling calibration apparatus according to claim 5, wherein the FBGs-based six-dimensional strain sensor is specifically as follows:
the FBGs-based six-dimensional strain sensor comprises a bracket (1), the base (10), the six strain sensing units that are respectively disposed in the six directions and have a same structure, the temperature sensing unit, optical fibers (5), a cylindrical encapsulation structure (8), and a temperature FBG (9), wherein each of the six strain sensing units comprises a hollow cylindrical tube (3), strain FBGs (4), and two circular discs (2); and the temperature sensing unit comprises a cover plate (6), a cylindrical cavity (7), and the cylindrical encapsulation structure (8);
the bracket (1) is configured to support the six strain sensing units in the six spatial directions, and bottoms of the six strain sensing units are fixed to the base (10); the strain FBG (4) is located in a center of the hollow cylindrical tube (3), and is fixed with an inner wall of the tube by using a fixative; the two circular discs (2) are arranged on an outer wall surface of the hollow cylindrical tube (3), and the circular disc (2) is configured to prevent sliding relative to the measured object in a measurement process; the base (10) is of a hollow cylindrical structure, and is internally nested with a coaxial hollow circular tube, the cylindrical encapsulation structure (8) and the temperature FBG (9) are disposed in the circular tube, the cover plate (6) is disposed on a top of the circular tube, a through hole for allowing the strain FBG (4) to pass through is formed in a middle of the cover plate (6), and the strain FBG (4) is connected to the temperature FBG (9); and the cylindrical cavity (7) is provided between the cylindrical encapsulation structure (8) and the cover plate (6); and the six strain FBGs (4) and one temperature FBG (9) are cascaded together and are arranged in the FBGs-based six-dimensional strain sensor in sequence; and the one temperature FBG (9) is arranged in a cavity of the base (10), to eliminate temperature interference in the measurement process; and the temperature FBG (9) is only affected by a temperature and is not affected by deformation of an external sensing apparatus, and is configured to perform temperature compensation as the temperature sensing unit.

9. The multidirectional strain decoupling calibration apparatus according to claim 8, wherein the six strain FBGs (4) and the one temperature FBG (9) are arranged as follows:
one end that is of the hollow cylindrical tube (3) and that is close to the base (10) is defined as an inner end, and the other end of the hollow cylindrical tube (3) is defined as an outer end; a first FBG gets in from the outer end of the hollow cylindrical tube (3) in the YZ direction and is fixed in the hollow cylindrical tube (3) in the YZ direction; after the first FBG (4) is fixed, an optical fiber guided out from the outer end of the hollow cylindrical tube (3) in the YZ direction gets in the hollow cylindrical tube (3) in the Y direction, and a second FBG (4) is fixed in the hollow cylindrical tube (3) in the Y direction; an optical fiber guided out from the inner end of the hollow cylindrical tube (3) in the Y direction gets in from the inner end of the hollow cylindrical tube (3) in the XY direction, and a third FBG (4) is fixed in the hollow cylindrical tube (3) in the XY direction; an optical fiber guided out from the outer end of the hollow cylindrical tube (3) in the XY direction gets in from the outer end of the hollow cylindrical tube (3) in the X direction, and a fourth FBG (4) is fixed in the hollow cylindrical tube (3) in the X direction; an optical fiber guided out from the inner end of the hollow cylindrical tube (3) in the X direction gets in from the inner end of the hollow cylindrical tube (3) in the XZ direction, and a fifth FBG (4) is fixed in the hollow cylindrical tube (3) in the XZ direction; an optical fiber guided out from the outer end of the hollow cylindrical tube (3) in the XZ direction gets in from the outer end of the hollow cylindrical tube (3) in the Z direction, and a sixth FBG (4) is fixed in the hollow cylindrical tube (3) in the Z direction; and an optical fiber (a tail end of which is provided with the temperature FBG (9)) guided out from an inner end of the hollow cylindrical tube (3) in the Z direction gets into the cavity (7) of the base (10), thereby completing arrangement of the six strain FBGs (4) and the one temperature FBG (9).

10. The multidirectional strain decoupling calibration apparatus according to claim 8, wherein the temperature sensing unit is arranged in the cylindrical cavity (7) of the base (10), specifically as follows:
a FBG fiber (4) fixed on an optical fiber guided out from the inner end of the hollow cylindrical tube (3) in the Z direction passes through the circular cover plate (6) with a hole, and then is fixed in the cylindrical encapsulation structure (8); a diameter of the cylindrical encapsulation structure (8) is less than a diameter of the cavity (7) in which a hollow groove for allowing the optical fiber to pass through is provided; and the cylindrical encapsulation structure (8) in which the FBG (4) is fixed is placed in the cavity (7), and the cavity is sealed via the cover plate (6), making the encapsulated temperature FBG (9) in the cavity only affected by a temperature and not affected by external force, to finally form the temperature sensing unit of the FBGs-based six-dimensional strain sensor.

11. The multidirectional strain decoupling method according to claim 7, wherein the micro-displacement electric control box (12) is a central control part in the entire decoupling calibration apparatus, and is capable of independently controlling the fixture (16) in each direction to move, and the fixture (16) has a compressing or stretching displacement under control of the micro-displacement electric control box (12), or is in a free state without force; and therefore complex strains in a plurality of spatial directions are simulated.
